(19) United States
(12) Patent Application Publication
(10) Pub. No.: US 2005/0118436 A1
(43) Pub. Date: Jun. 2, 2005

(54) Method for electroless deposition of a metal layer on selected portions of a substrate

(76) Inventors: Sunil Madhukar Bhangale, Singapore (SG); Zhongli Li, Singapore (SG); Peter Malcolm Moran, Singapore (SG)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/512,113

(22) PCT Filed: Apr. 23, 2003
(86) PCT No.: PCT/SG03/00093

(30) Foreign Application Priority Data
Apr. 23, 2002 (SG) 0202366-1

(51) Int. Cl. B05D 5/00; B32B 15/04

(52) U.S. Cl. 428/457; 427/282; 427/304

(57) ABSTRACT

The present invention relates to a method for electroless deposition of a metal layer on selected portions of a substrate. A preferred form of the invention relates to a method of depositing a desired metal layer, by electroless deposition, on one or more selected portions of an indium tin oxide (ITO) surface of a substrate. These selected portions are typically transparent conductive paths of ITO. The method includes a number of steps including applying a masking layer onto the surface, the masking layer having one or more apertures formed therein so as to expose the one or more selected portions of the surface: exposing the one or more selected portions of the surface to a colloidal suspension of catalytic particles adapted to adsorb to the substrate surface and to enhance deposition of the desired metal layer, and exposing the one or more selected portions of the surface to an ionic solution containing ions of the desired metal to enable formation of the metal layer.

### TECHNICAL FIELD

The present invention relates to a method for electroless deposition of a metal layer on selected portions of a substrate. A preferred form of the invention relates to a method of depositing a desired metal layer, by electroless deposition, on one or more selected portions of an indium tin oxide (ITO) surface of a substrate. These selected portions are typically transparent conductive paths of ITO.

### BACKGROUND TO THE INVENTION

In this specification, where a document, act or item of knowledge is referred to or discussed, this reference or discussion is not an admission that the document, act or item of knowledge or any combination thereof, was at the priority date:
(a) part of the common general knowledge; or
(b) known to be relevant to any attempt to solve any problem with which this specification is concerned.

Wet chemical metallisation of semiconductors has substantial industrial and commercial significance. This metallisation is generally effected by means of electroless plating on a suitable substrate. Such substrates typically include metals, ceramics (including glass) and polymers.

When, for example, it is desired to deposit nickel on such a substrate by electroless deposition, the substrate is typically immersed in a solution containing a reducing agent and nickel ions (Ni²⁺). The nickel ions are reduced by the reducing agent, usually in the presence of a suitable catalyst. It is usual practice to catalytically activate the surface of the substrate which is to be plated so as to confine deposition of the metal to the desired substrate surface. A common catalyst used in this reaction is palladium.

However, it is often difficult to selectively deposit the desired metal layer on selected portions of the substrate surface. This is because, when a substrate surface is activated, the metal will tend to deposit on all of the activated surface. Therefore, it may then be necessary to deactivate portions of the surface where the metal is not to be deposited.

For example, U.S. Pat. No. 4,824,693 discloses a method of depositing a solderable metal layer, by an electroless process, on transparent conductive paths of ITO on certain substrates (including glass substrates). The invention of U.S. Pat. No. 4,824,693 involves activating the surface of the conductive paths by immersing the entire substrate surface in a bath of palladium chloride and tin chloride then deactivating the areas not covered by the conductive paths (by immersing the substrate in hydrofluoric acid). The process then includes deposition of the metal layer by an electroless method. The metal will deposit on the remaining activated portions of the surface. As can be seen, in the method of U.S. Pat. No. 4,824,693, the activation of the surface is not selective and, therefore, portions of the ITO surface must then be deactivated prior to the metal deposition.

European Patent No. 0 518 422 A2 discloses a method for selectively activating an ITO surface of a glass substrate. This patent uses polymer-stabilised colloidal particles that selectively adsorb to the ITO surface and do not adsorb to the glass substrate. However, this patent only describes how to activate all of the ITO surface of the substrate and it does not contain any indication as to how to selectively activate desired portions of the ITO surface.

The present invention is directed towards an improved method for selectively activating a substrate so as to facilitate metallic deposition thereon.

This invention is further directed towards an improved method of selectively activating and plating desired portions of a substrate, in particular, an ITO surface of a substrate.

### SUMMARY OF THE INVENTION

According to a first aspect of this invention, there is provided a method for the electroless deposition of a desired metal layer on one or more selected portions of a substance surface, wherein the method includes the steps of:
applying a masking layer onto the surface of the substrate, said masking layer adapted to have one or more apertures formed therein so as to expose the one or more selected portions of the surface;
exposing the one or more selected portions of the surface to a colloidal suspension of catalytic particles adapted to adsorb to the substrate surface and to enhance deposition of the desired metal layer thereon; and
exposing the one or more selected portions of the surface to an ionic solution containing ions of the desired metal to enable formation of the metal layer.

It is preferred that the one or more apertures are formed in the masking layer after applying the layer to the substrate surface.

It is further preferred that the substrate surface has a film of ITO formed thereon. This film may cover all of, or a portion of, the substrate surface. Alternatively, the film may be applied in patches to the substrate surface.

Preferably, at least some of the one or more apertures of the masking layer lie over one or more portions of the ITO film.

It is preferred that the colloidal suspension comprises particles of catalytic metal which are adapted to adsorb to the ITO film but not to the substrate material. One particularly preferred catalytic metal is palladium. A preferred substrate material is glass.

The suspension of catalytic metal particles is generally polymer-stabilised, so as to inhibit the metal particles from agglomerating and precipitating from the solution. This polymer stabilisation is preferably achieved using polyvinyl alcohol (PVA) or poly(vinylpyrrolidone) (PVP). The catalytic metal particles may also be stabilised with a solution containing tin ions or a combination of tin ions and the polymers mentioned above.

The masking layer may be formed of a photosensitive material. Suitable such masking layers are dry film resists which may be selected from Ashahi Chemical's Sunfort™ resists. Alternatively, the dry film resist may be selected from DuPont's Riston™ resists. Alternatively, the masking layer may be formed of a polymeric material to which no substantial adherence of the catalytic particles occurs. Similarly, the catalytic particles may be selected on the basis that they do not (to any significant extent) adhere to the polymeric material. The polymeric material is typically selected from the group consisting of suitable polycarbonates, fluorinated polymers, cellophane, polyimide and acrylate-based polymers. The masking layer is preferably applied by coating the substrate surface with a thin layer of a photoresistive polymer. This coating can be achieved by spin coating a liquid resist on the substrate surface and subsequently curing and/or drying the liquid resist. Alternatively, the masking layer may be applied by spraying an aerosol of a suitable polymeric material (such as those described above) onto the substrate surface.

Another means of applying the masking layer is to laminate a film of the resist onto the substrate surface. Particularly suitable films for this purpose are the dry film resists mentioned above. This lamination typically involves placing the film on top of the substrate and then feeding them between two rollers that apply pressure and heat causing the film and substrate to adhere to each other.

The one or more apertures in the masking layer may be formed either before of after the masking layer has been applied to the substrate. However, it is generally preferable to form the apertures after applying the masking layer to the substrate.

Typically, the apertures are formed using UV lithography (in the case of photosensitive materials), a laser or screening means. Preferably, a photosensitive material is used for the patterning. This UV lithography typically involves exposing the photoresist to UV light selectively, such as through a UV mask. The UV mask is usually a patterned thin layer of metal on glass.

Some resists are ‘positive’ meaning that the regions of such resists which are exposed to UV light are broken down and become soluble in the developing agent. Other resists are ‘negative’, meaning that the regions of such resists which are exposed to UV light harden and become insoluble to the developing agent.

After exposure to UV light, the layered substrate is immersed in a suitable developing agent adapted to selectively remove the exposed regions of the resist (in the case of ‘positive’ resists) or the unexposed regions of the resist (in the case of ‘negative’ resists). This results in the desired patterns (of apertures) being formed in the masking layer.

It is preferred that, prior to performing the step of exposing the selected portions of the substrate to the colloidal solution, the layered substrate is cleaned to remove any residues of polymeric or organic material. This cleaning may be effected by plasma cleaning or by UV ozone cleaning techniques.

The step of exposing the one or more selected portions of the substrate to the colloidal suspension is generally effected by dipping the substrate, containing the masking layer, into a bath of the colloidal suspension. The substrate may be removed from the suspension after a few seconds, or longer if necessary. After exposing the selected portions to the colloidal suspension, the method preferably includes the further step of rinsing the selected portions, which is preferably done with deionized water (DI water). After the rinsing step, the selected portions should be dried. Drying can be effected by placing the layered substrate in an oven to remove substantially all of the water from the selected portions, and/or by blowing the substrate with a stream of gas, such as nitrogen or air.

The step of exposing the one or more selected portions to the ionic solution is generally effected by dipping the substrate containing the masking layer into a bath of the ionic solution.

It is preferred that, after the metal layer has been formed, the masking layer is removed. However, it is also possible for the masking layer to be removed after exposing the selected portions to the colloidal suspension but prior to exposing the one or more selected portions to the ionic solution. Removal of the masking layer is typically facilitated by using a strong base (such as potasium hydroxide) which strongly attaches the masking layer (resist) irrespective of whether it has been exposed or not.

The desired metal for deposition on the substrate is typically copper, nickel, chromium, molybdenum, tantalum or any alloys of these. Copper or nickel are particularly preferred as the desired metal.

In a particularly preferred embodiment of this invention, the method is effected by performing the following steps:
applying a masking layer on to the surface of the substrate;
forming the desired apertures in the masking layer;
dipping the substrate into the colloidal suspension of catalytic particles;
rinsing the substrate with clean water immediately after dipping it in the colloidal suspension;
drying the substrate (usually with flowing air or nitrogen) and then further drying it in an oven;
immersing the substrate in an electroless metallisation bath until the desired thickness of the desired metal is deposited on the one or more selected portions of the surface of the substrate; and
stripping the masking layer from the substrate.

Additional steps may be included to further facilitate the method. For instance, prior to applying the masking layer, an ITO film (or portions of such a film) may be applied to the substrate surfaces.

The colloidal suspension referred to above contains catalytic particles, which are typically catalytic metals such as palladium. Preferably the colloidal solution is prepared as follows:
dissolving 100 mg (although it could be anywhere from about 25 mg to about 500 mg) of PVP (weight averaged molecular weight=50,000—although it could be anywhere between about 10,000 to about 500,000) in DI water;
dissolving 150 mg of PdCl₂ in 5.25 ml of HCl (37% aqueous solution);
mixing the PVP and the PdCl₂ solutions together;
slowly adding 10-35 ml of hypophosphorous acid (H₃O₂P) (50% aquoeus solution) to the solution (or an appropriate quantity of another suitable reducing agent);
adding DI water until the total volume of the solution is about 1 litre.

The PVP stabilised palladium colloidal solution (the “Pd/PVP sol”) is very stable and can be kept for months under normal conditions without noticeable change.

In preparing the substrate for the metal deposition, a clean substrate, having an ITO film or ITO pattern on its surface, is taken and coated with a masking layer (or “resist”) of the type described above.

The resist needs to be patterned so that the patterns correspond with the selected portions of the substrate on to which the desired metal layer is to be deposited. Preferably a photoresistive material is used for the patterning. Patterning of the photoresist on the substrate surface generally follows procedures known in the art. These include exposure of selected regions of the photoresist to UV light. Thereafter the resist is immersed in a developing agent to selectively dissolve and remove the resist. The exposed areas on the substrate should be cleaned after patterning of the resist so as to remove any residues of polymeric or organic material left on the surface of the substrate.

The clean patterned substrate is then dipped into the Pd/PVP sol. Usually the substrate only needs to be dipped into the solution for a few seconds. Upon removal of the substrate from the solution, it should be immediately rinsed thoroughly with DI water. The substrate may then be dried with nitrogen or air and may then be placed in an oven to remove any remaining moisture.

The substrate is then placed in an electroless plating bath to deposit the desired thickness of metal on the exposed selected portions of the substrate.

Generally, the particles in the Pd/PVP sol do not adhere to the resist and, therefore, no plating generally occurs on the resist. The resist may then be removed from the substrate. Alternately, the resist may be removed from the substrate prior to the metal deposition step (but after the step of activating the substrate with the Pd/PVP sol). In certain cases, however, it may be desirable to leave the resist on the substrate.

### DRAWINGS

FIG. 1 is a flow chart of a method according to a preferred embodiment of this invention.

FIG. 2 is a schematic perspective view of a substrate according to a preferred embodiment of this invention.

FIG. 3 is a schematic perspective view of a substrate with masking layer (resist) applied thereto, according to a preferred aspect of this invention.

FIG. 4A is a schematic perspective view of the substrate and masking layer of FIG. 3 in which the masking layer is patterned to expose selected portions of the substrate, according to a preferred aspect of this invention.

FIG. 4B is a schematic plan view of the substrate and masking layer of FIG. 4A.

FIG. 5 is a side cross-sectional view of a bath of colloidal solution into which the substrate and masking layer of FIGS. 4A and 4B is being dipped.

FIG. 6 is a side cross-sectional view of a bath, containing metal ions of the metal to be deposited on the substrate, into which the substrate and masking layer is being dipped.

FIG. 7 is a schematic side view of the substrate of FIGS. 4A and 4B with partially removed masking layer, following the metal deposition steps according to a preferred aspect of this invention.

FIG. 8 is a schematic perspective view of the substrate (with masking layer removed) after the metal deposition, according to a preferred embodiment of this invention.

FIG. 9 is an optical microscope image of a partial plan view of the substrate and masking layer following metal deposition.

FIG. 10 is an enlarged view of a portion of the substrate and masking layer of FIG. 9.

FIG. 11 is a further enlarged view of a portion of the substrate and masking layer of FIG. 10.

FIG. 12 is an optical microscope image of a partial plan view of the substrate, showing metal deposited on selected portions of the substrate (with masking layer removed).

FIG. 13 is an enlarged view of a portion of the substrate of FIG. 12.

FIG. 14 is a further enlarged view of a portion of the substrate of FIG. 12.

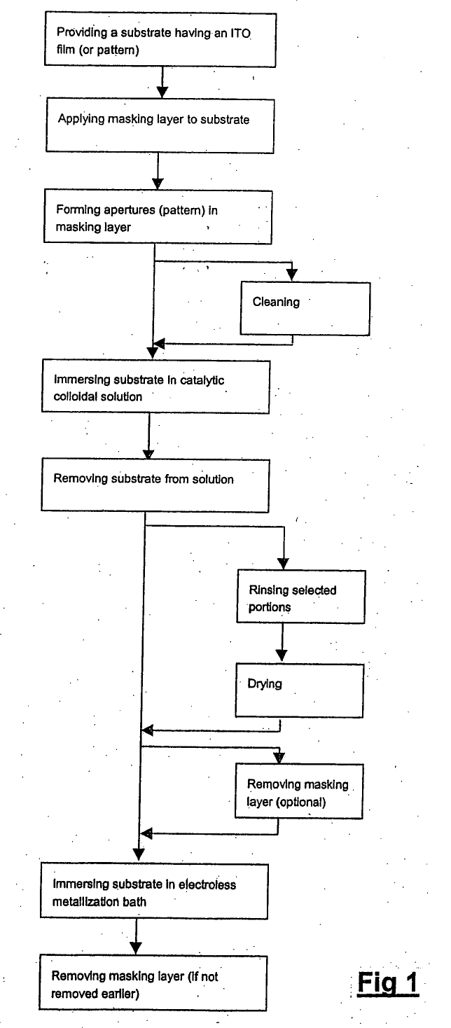

### BRIEF DESCRIPTION OF THE DRAWINGS

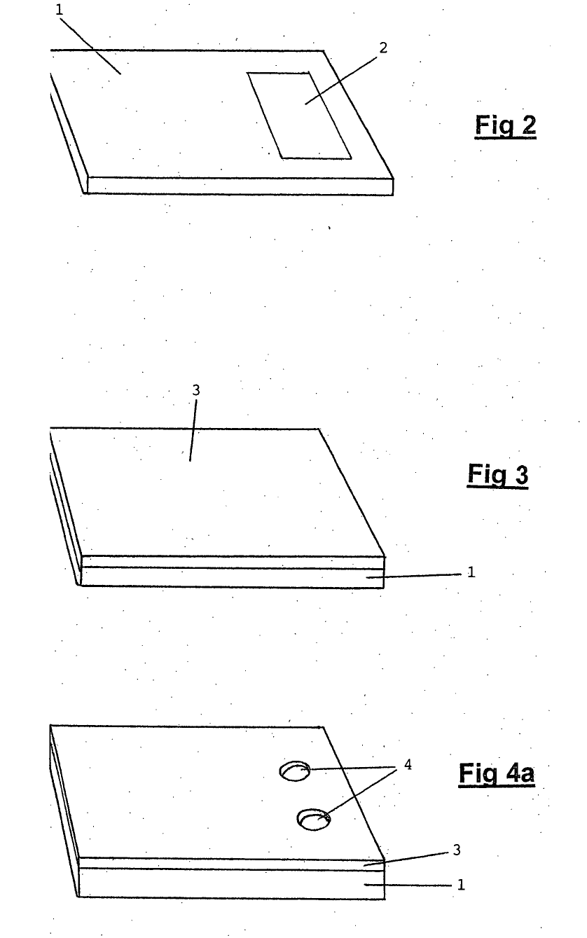

As shown in FIGS. 2 and 3, the substrate 1 is a substantially rectangular support on an upper surface of which is located a film of ITO 2. A masking layer (resist) 3 is placed over the upper surface of the substrate.

FIG. 3 shows the masking layer 3 as covering the entire upper surface of the substrate 1. This may be preferred, for example, in situations where the seeding particles (and therefore the deposited metal) may otherwise adhere to the substrate. However, where the seeding particles do not (at least, to a significant degree) adsorb to the substrate, the masking layer may be dimensioned so as only to cover the ITO film. As shown in FIGS. 4A and 4B, the masking layer 3 is patterned with shaped holes 4. Shaped holes 4 are dimensioned so as to correspond with the selected portions of the substrate on to which metal is to be deposited.

FIG. 5 shows the layered substrate 1 being dipped into a bath 5 containing a colloidal suspension 6 of catalytic metal particles, namely palladium.

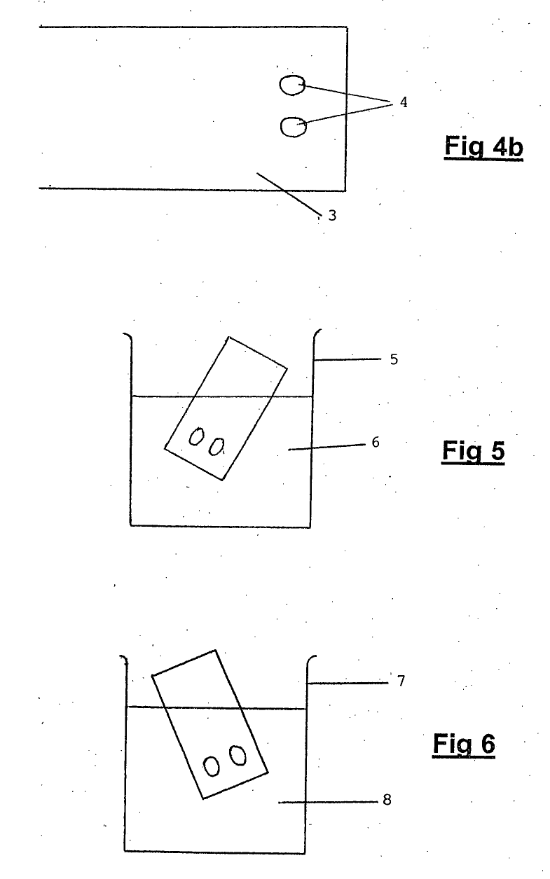

FIG. 6 shows the layered substrate 1 being dipped into a bath 7 of an ionic solution 8 containing ions of the desired metal (eg. nickel).

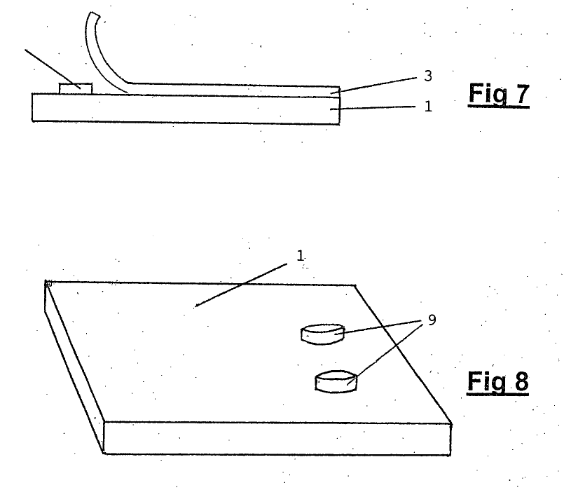

FIG. 7 shows the layered substrate 1, with the masking layer 3 partially removed from the substrate 1, following the step of metal deposition and showing a metal portion 9 deposited on the substrate 1.

FIG. 8 shows the substrate 1 having metal portions 9 deposited on the selected portions of the substrate 1.

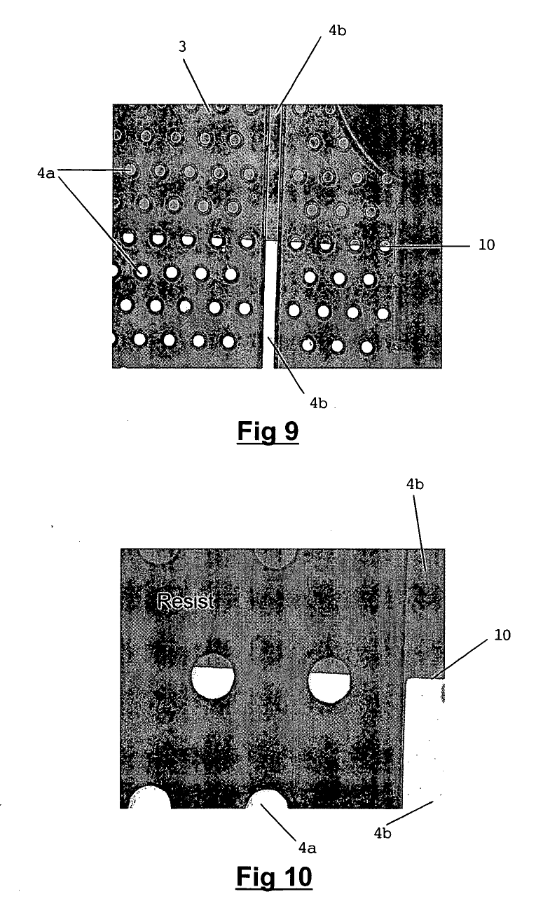

FIGS. 9 and 10 show a portion of the upper surface of the substrate 1 following metal deposition but prior to removal of the masking layer 3. The masking layer 3 contains a multitude of shaped holes (most of which are circular 4a and one of which is linear 4b). In the embodiment shown in FIGS. 9 and 10, a clear dividing line 10 can be seen—above which no metal has been deposited and below which metal has been deposited. Below the dividing line 10, metal can be seen to have been deposited in the shaped holes of the masking layer 3. This deposition occurred because of the presence of the seeded ITO film on the substrate.

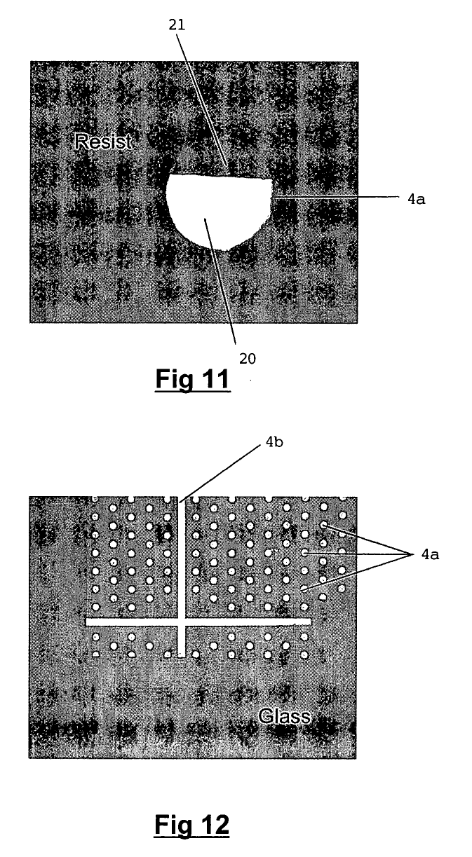

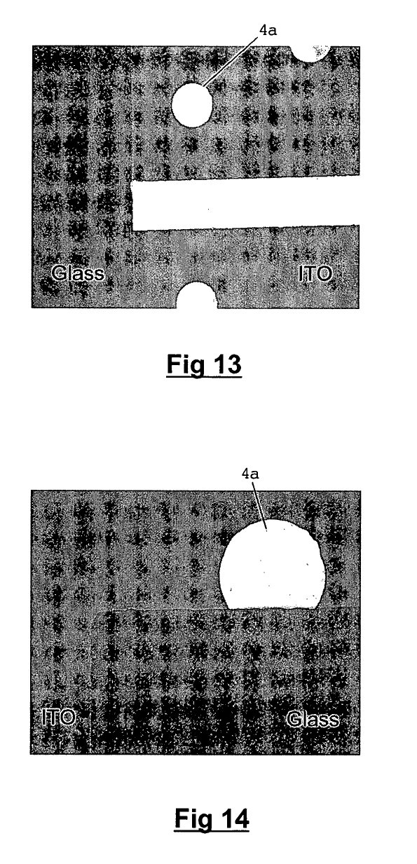

FIG. 10 is an enlarged version of a portion of FIG. 9 showing the portion of the substrate surface (with masking layer) near the dividing line 10. As can be seen, in the shaped holes 4a, 4b which are above the dividing line 10, being those which overlay portions of the substrate on which the ITO film had not been deposited, the metal did not adhere. This is also shown in FIGS. 11, 12, 13 and 14 (in all of which the masking layer 3 has been removed). FIG. 11 shows a single circular shaped hole 4a which contains a metallised section 20 and a non-metallised section separated by the dividing line 10.

The invention described above provides a selective method of seeding and plating only certain portions of a substrate having an ITO film. This enables simple, accurate patterning (eg. on the microscale) of the substrate.

Modifications and improvements to the invention will be readily apparent to those skilled in the art. Such modifications and improvements are intended to be within the scope of this invention.

1. A method for the electroless deposition of a desired metal layer on one or more selected portions of a substrate surface, wherein the method includes the steps of:
applying a masking layer onto the surface, said masking layer adapted to have one or more apertures formed therein so as to expose the one or more selected portions of the surface;
exposing the one or more selected portions of the surface to a colloidal suspension of catalytic particles adapted to adsorb to the substrate surface and to enhance deposition of the desired metal layer thereon; and
exposing the one or more selected portions of the surface to an ionic solution containing ions of the desired metal to enable formation of the metal layer.

2. A method according to claim 1, wherein the one or more apertures are formed in the masking layer after applying the layer to the substrate surface.

3. A method according to claim 1 or claim 2, wherein the substrate has a film of indium tin oxide (ITO) formed thereon.

4. A method according to claim 3 wherein at least some of the one or more apertures of the masking layer lie over one or more portions of the ITO film.

5. A method according to any one of claims 1 to 4, wherein the colloidal suspension includes particles of catalytic metal.

6. A method according to claim 5, wherein, when the substrate surface includes a film of ITO formed thereon, the catalytic metal and the material of the substrate are selected so that no substantial adsorption of the catalytic metal occurs on the substrate material.

7. A method according to claim 5 or claim 6, wherein the catalytic metal is palladium.

8. A method according to any one of claims 5 to 7, wherein the catalytic metal particles are polymer-stabilised.

9. A method according to claim 8, wherein the catalytic metal particles are stabilised with polyvinyl alcohol, poly(vinylpyrrolidoine) or a combination of these.

10. A method according to any one of claims 5 to 7, wherein the catalytic metal particles are stabilised with a solution containing tin ions.

11. A method according to any one of claims 6 to 10, wherein the substrate material is glass.

12. A method according to any one of claims 1 to 11, wherein the masking layer is formed of a polymeric material to which no substantial adherence of the catalytic particles occurs.

13. A method according to claim 12, wherein the polymeric material is selected from the group consisting of suitable polycarbonates, fluorinated polymers, cellophane, polyimide and acrylate-based polymers.

14. A method according to claim 12 or claim 13, wherein the polymeric material is a photoresist.

15. A method according to any one of claims 1 to 14, wherein the masking layer is formed of a dry film resist.

16. A method according to claim 15, wherein the dry film resist is selected from the group consisting of Asahi Chemical's Sunfort™ resists and DuPont's Riston™ resists.

17. A method according to any one of claims 12 to 16, wherein the one or more apertures in the masking layer are formed using UV lithography, a laser or screening means.

18. A method according to any one of claims 1 to 17 wherein, prior to the step of exposing the selected portions of the substrate to the colloidal solution, the layered substrate is cleaned to remove any residues of polymeric or organic material.

19. A method according to claim 18, wherein the cleaning is effected by plasma cleaning or UV ozone cleaning techniques.

20. A method according to any one of claims 1 to 19, wherein the step of exposing the one or more selected portions of the substrate to the colloidal solution is effected by dipping the substrate containing the masking layer into a bath of the colloidal solution.

21. A method according to any one of claims 1 to 20, wherein, after the step of exposing the one or more selected portions of the substrate to the colloidal solution, the selected portions are rinsed with de-ionised water.

22. A method according to claim 21 wherein, after the rinsing step, the selected portions are dried to remove substantially all of the water from the selected portions.

23. A method according to claim 22, wherein the drying step includes placing the layered substrate in an oven.

24. A method according to claim 22, wherein the drying step includes blowing a stream of gas over the layered substrate.

25. A method according to any one of claims 1 to 25, wherein the drying step includes both placing the layered substrate in an oven and blowing it with a stream of gas.

26. A method according to claim 24, wherein the step of exposing the one or more selected portions to the ionic solution is effected by dipping the substrate containing the masking layer into a bath of the ionic solution.

27. A method according to any one of claims 1 to 26 wherein, after formation of the metal layer, the masking layer is removed.

28. A method according to claim 27 wherein a strongly basic solution is used to facilitate removal of the masking layer.

29. A method according to any one of claims 1 to 25, wherein the masking layer is removed prior to the step of exposing the one or more selected portions to the ionic solution.

30. A method according to any one of claims 1 to 29, wherein the desired metal is selected from the group consisting of copper, nickel, chromium, molybdenum, tantalum and any alloy of these metals.

31. A method according to claim 30, wherein the desired metal is selected from copper and nickel.

32. A method for the electroless deposition of a desired metal layer on one or more selected portions of a substrate surface, substantially as herein before described with reference to any one or more of the drawings.

33. A product made according to the method of any one or more of claims 1 to 32.
